(19) United States
(12) Patent Application Publication
(10) Pub. No.: US 2026/0092239 A1
(43) Pub. Date: Apr. 2, 2026

(54) CLEANING COMPOSITION

(71) Applicant: DONGWOO FINE-CHEM CO., LTD., Jeollabuk-do (KR)

(72) Inventors: SOON HONG PANG, Jeollabuk-do (KR); TAE HEE KIM, Jeollabuk-do (KR); JEONG HYUN KIM, Jeollabuk-do (KR); HAN BYEOL KANG, Jeollabuk-do (KR); HYUNG JIN CHO, Jeollabuk-do (KR)

(21) Appl. No.: 19/344,919

(22) Filed: Sep. 30, 2025

(30) Foreign Application Priority Data
Sep. 30, 2024 (KR) 10-2024-0132934
Aug. 27, 2025 (KR) 10-2025-0120262

(51) Int. Cl. C11D 7/28; C11D 7/32; C11D 7/34; C11D 7/36; C11D 7/50

(52) U.S. Cl. CPC C11D 7/28; C11D 7/3209; C11D 7/3263; C11D 7/34; C11D 7/36; C11D 7/5009; C11D 7/5013; C11D 7/5022; C11D 2111/22

(57) ABSTRACT

A cleaning composition includes a cyclic amide-based compound represented by Chemical Formula 1, a polar aprotic solvent, and a fluorine-based compound. The cleaning composition can rapidly remove a silicon-based polymer without generating residue and etching a metal layer. The cleaning composition can be used for a cleaning process of a wafer in a fabrication of a semiconductor device.

### CROSS-REFERENCE TO RELATED APPLICATION AND CLAIM OF PRIORITY

This application claims priority to Korean Patent Application Nos. 10-2024-0132934 filed on Sep. 30, 2024 and 10-2025-0120262 filed on Aug. 27, 2025 in the Korean Intellectual Property Office (KIPO), the entire disclosures of which are incorporated by reference herein.

### BACKGROUND

### 1. Field

The present invention relates to a cleaning composition.

### 2. Description of the Related Art

In a fabrication of a semiconductor device, an electronic circuit, etc., may be formed on a surface of a semiconductor wafer, and then a thickness of the wafer may be reduced by performing a rear surface grinding (e.g., a back grinding). In this case, a supporter may be attached to a circuit surface of the wafer using a silicone-based resin for protecting the circuit surface of the wafer and fixing the wafer. The wafer having a reduced thickness may be reinforced by the supporter, and a rear surface electrode, etc., may be formed on the grinding surface of the wafer.

After performing the processes such as the rear surface grinding and the rear electrode formation of the wafer, the supporter may be removed from the circuit surface of the wafer, the attached silicon-based resin may be peeled off, and the wafer may be cut to manufacture a chip.

Recently, a chip stacking technology using a through electrode (e.g., a silicon through electrode) penetrating the wafer has been developed. In this case, an electronic circuit of a plurality of chips may be electrically connected using the through electrode. Thus, a high integration and an operation speed of the chip may be improved.

To reduce a thickness of the assembly in which the plurality of chips are stacked, the supporter and the silicone-based resin may be coupled to the wafer as described above after performing the rear surface grinding of the wafer.

A thermal curing may be performed to increase adhesion between the wafer and the supporter. When the silicone-based resin is peeled off, the silicone resin attached to a cured electronic component may remain on the supporter and the circuit surface of the wafer.

In a method of removing the silicon-based adhesives, various cleaning compositions have been developed. However, a metal wiring may be etched or a removing rate of the silicon-based adhesive may be degraded by the cleaning composition.

### SUMMARY

According to an aspect of the present invention, there is provided a cleaning composition having enhanced cleaning capability.
(1) A cleaning composition including a cyclic amide-based compound represented by Chemical Formula 1, a polar aprotic solvent, and a fluorine-based compound:

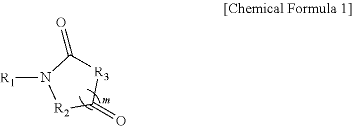

wherein, R₁ is hydrogen, a C1 to C5 alkyl group, or a C2 to C5 alkenyl group,
one of R₂ and R₃ is a C1 to C15 alkylene group, a C2 to C15 alkenylene group, a C3 to C20 cycloalkylene group, a C3 to C20 cycloalkenylene group or a C6 to C20 arylene group, the other of R₂ and R₃ is a direct bond, a C1 to C15 alkylene group, a C2 to C15 alkenylene group, a C3 to C20 cycloalkylene group, a C3 to C20 cycloalkenylene group, a C3 to C10 heteroarylene group, a C3 to C10 heterocycloalkylene group or a C6 to C20 arylene group, and m is 0 or 1.
(2) The cleaning composition of the above (1), wherein, in Chemical Formula 1, R₂ is a C3 to C7 alkylene group or a C6 to C9 arylene group.
(3) The cleaning composition of the above (1), wherein, in Chemical Formula 1, R₁ is hydrogen, a methyl group, or a vinyl group.
(4) The cleaning composition of the above (1), wherein the cyclic amide-based compound includes at least one selected from the group consisting of γ-valerolactam, ε-caprolactam, N-methyl-ε-caprolactam, N-vinyl-ε-caprolactam, ω-heptalactam, ω-octalactam, glycyl-L-prolinelactam, isatin, and vince lactam.
(5) The cleaning composition of the above (1), wherein a content of the cyclic amide-based compound is in a range from 0.001 wt % to 10 wt % based on a total weight of the composition.
(6) The cleaning composition of the above (1), wherein the polar aprotic solvent includes at least one selected from the group consisting of a linear amide-based solvent, an amine-based solvent, a ketone-based solvents, a morpholine-based solvent, a pyrrolidine-based solvent, a pyrrolidone-based solvent, a urea-based solvent, a lactone-based solvent, a sulfoxide-based solvent, a phosphate-based solvent, an oxazolidone-based solvent, a piperazine-based solvent, and an alkylene glycol alkyl ether-based solvent.
(7) The cleaning composition of the above (1), wherein a content of the polar aprotic solvent is in a range from 88 wt % to 99 wt % based on a total weight of the composition.
(8) The cleaning composition of the above (1), wherein the fluorine-based compound has an ionic bond of a nitrogen-based cation, a phosphorus-based cation or a sulfur-based cation, and a fluorine anion.
(9) The cleaning composition of the above (8), wherein the nitrogen-based cation includes an ammonium-based cation bonded with three or more C1 to C10 alkyl groups.
(10) The cleaning composition of the above (1), wherein the fluorine-based compound is in the form of a hydrate.
(11) The cleaning composition of the above (1), wherein the fluorine-based compound includes at least one selected from the group consisting of tetrabutylammonium bifluoride, tetrabutylammonium fluoride, tetraoctylammonium fluoride, benzyltrimethylammonium fluoride, tetra-n-butylammonium fluoride hydrate, tetra-n-butylammonium fluoride trihydrate, benzyltrimethylammonium fluoride hydrate, tributylsulfonium fluoride, and tetrabutylphosphonium fluoride.
(12) The cleaning composition of the above (1), wherein a content of the fluorine-based compound is in a range from 1 wt % to 12 wt % based on a total weight of the composition.
(13) The cleaning composition of the above (1), wherein the cleaning composition does not contain an ammonium hydroxide compound, a metal hydroxide, an alcohol compound, a carboxylic acid compound, a peroxide compound, or an inorganic acid compound.

A cleaning composition according to embodiments of the present invention may efficiently remove a silicone-based resin of a linear-type, a network-type, etc. Further, the cleaning composition may selectively remove the silicone-based resin without etching or corroding a metal member.

The cleaning composition may decompose and dissolve the silicon-based resin into silicone-based oligomer units to remove the silicon-based resin. Accordingly, the silicone-based resin may be removed more quickly, and a high-quality semiconductor device may be provided.

### DETAILED DESCRIPTION OF THE EMBODIMENTS

According to exemplary embodiments of the present invention, a cleaning composition including a cyclic amide-based compound, a polar aprotic solvent, and a fluorine-based compound.

Hereinafter, the present invention will be described in detail with reference to embodiments. However, those skilled in the art will appreciate that such embodiments are provided to further understand the spirit of the present invention, and do not limit subject matters to be protected as disclosed in the detailed description and appended claims.

As used herein, the term “a Ca to Cb Y group” refers to a Y group having the number of carbon atoms in a range from a to b. For example, “Ca to Cb” refer to the number of carbon atoms of the Y group in an unsubstituted state, and an additional substituent may be bonded to the Y group.

In a semiconductor fabrication, transfer, surface treatment, and another member attachment processes may be performed in a state that temporary members are attached. The attachment may be performed using a silicone-based adhesive. After performing the processes in the state that the temporary members are attached, the members may be separated from each other. After separating the members, the silicone-based adhesive may remain on a surface of an individual member. The silicone-based adhesive may be cleaned and removed using the cleaning composition according to embodiments of the present invention.

The cleaning composition includes a fluorine-based compound. The fluorine-based compound may react with a silicon atom and break a chain of a silicone-based polymer to decompose the silicone-based polymer into a silicone-based oligomer.

According to embodiments, the fluorine-based compound may be in the form of a hydrate. For example, the fluorine-based compound may be a hydrate in which 5 or less water molecules per molecule are combined. The fluorine-based compound in the form of the hydrate may include a nitrogen-based cation as described below.

The fluorine-based compound may include an ionic bond of the nitrogen-based cation, a phosphorus-based cation or a sulfur-based cation, and a fluorine anion. For example, the fluorine-based compound may include an ionic bond of an ammonium-based cation, a phosphonium-based cation or a sulfonium-based cation, and the fluorine anion.

In example embodiments, the nitrogen-based cation may include an ammonium-based cation in which three or more C1 to C10 alkyl groups are combined. For example, the nitrogen-based cation may include four C1 to C10 alkyl groups, or three C1 to C10 alkyl groups and a C6 to C20 aromatic group. The aromatic group may include, e.g., a phenyl group, a benzyl group, or the like.

The phosphorus-based cation may include a phosphonium-based cation. The phosphonium-based cation may include four organic groups bonded to a phosphorus atom. The organic group may include a C1 to C22 aliphatic hydrocarbon group or a C6 to C20 aromatic group. For example, the phosphorus-based cation may be a tetrabutylphosphonium cation.

The sulfur-based cation may include a sulfonium-based cation. The sulfonium-based cation may include three organic groups bonded to a sulfur atom. The organic group may include a C1 to C22 aliphatic hydrocarbon group or a C6 to C20 aromatic group. For example, the sulfur-based cation may be a tetrabutylsulfonium cation.

In example embodiments, the fluorine-based compound may include tetrabutylammonium bifluoride, tetrabutylammonium fluoride (TBAF), tetraoctylammonium fluoride (TOAF), benzyltrimethylammonium fluoride (BTMAF), tetra-n-butylammonium fluoride hydrate, tetra-n-butylammonium fluoride trihydrate, benzyltrimethylammonium fluoride hydrate, tributylsulfonium fluoride, tetrabutylphosphonium fluoride, or the like. These may be used alone or in a combination of two or more therefrom.

In example embodiments, a content of the fluorine-based compound may be in a range from 0.1 wt % to 20 wt % based on a total weight of the composition. In some embodiments, the content of the fluorine-based compound may be in a range from 3 wt % to 10 wt % based on the total weight of the composition.

In the above range, the silicone-based adhesive may be rapidly and effectively removed without corroding a metal film.

The cleaning composition according to embodiments include a cyclic amide-based compound. The cyclic amide-based compound may prevent corrosion of an exposed metal film without inhibiting a removal reaction of the silicone-based polymer by the fluorine-based compound.

The cyclic amide-based compound may be represented by Chemical Formula 1 below.

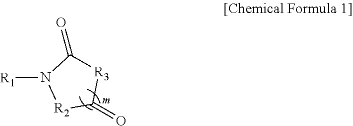

In Chemical Formula 1, R₁ may be hydrogen, a C1 to C5 alkyl group, or a C2 to C5 alkenyl group. In some embodiments, R₁ may be hydrogen, a C1 to C3 alkyl group, or a C2 to C4 alkenyl group. For example, R₁ may be hydrogen, a methyl group, or a vinyl group.

In Chemical Formula 1, one of R₂ and R₃ may be a C1 to C15 alkylene group, a C2 to C15 alkenylene group, a C3 to C20 cycloalkylene group, a C3 to C20 cycloalkenylene group, or a C6 to C20 arylene group.

The other of R₂ and R₃ may be a direct bond, a C1 to C15 alkylene group, a C2 to C15 alkenylene group, a C3 to C20 cycloalkylene group, a C3 to C20 cycloalkenylene group, a C3 to C10 heteroarylene group, a C3 to C10 heterocycloalkylene group, or a C6 to C20 arylene group.

In some embodiments, R₂ may be a C1 to C15 alkylene group, a C2 to C15 alkenylene group, a C3 to C20 cycloalkylene group, a C3 to C20 cycloalkenylene group, or a C6 to C20 arylene group. R₃ may be a direct bond, a C1 to C15 alkylene group, a C2 to C15 alkenylene group, a C3 to C20 cycloalkylene group, a C3 to C20 cycloalkenylene group, a C3 to C10 heteroarylene group, a C3 to C10 heterocycloalkylene group, or a C6 to C20 arylene group.

In some embodiments, R₂ may be a C1 to C8 alkylene group, a C2 to C8 alkenylene group, a C4 to C7 cycloalkenylene group, a C3 to C6 heterocycloalkylene group, or a C6 to C12 arylene group. R₃ may be a direct bond.

In some embodiments, R₃ may be a C1 to C8 alkylene group, a C2 to C8 alkenylene group, a C4 to C7 cycloalkenylene group, a C3 to C6 heterocycloalkylene group, or a C6 to C12 arylene group. R₂ may be a direct bond.

The alkylene group may be a divalent linear or branched saturated hydrocarbon group such as a methylene group, an ethylene group, a propylene group, or the like.

The alkenylene group may be a divalent linear or branched unsaturated hydrocarbon group containing a carbon-carbon double bond, such as an ethenylene group, a propenylene group, or the like.

The cycloalkenylene group may be a divalent cyclic unsaturated hydrocarbon group containing a carbon-carbon double bond, such as a cyclopentenylene group, a cyclohexenylene group, or the like.

The heterocycloalkylene group may be a divalent cyclic saturated organic group containing at least one heteroatom such as nitrogen, oxygen, sulfur, phosphorus, or the like. For example, the heterocycloalkylene group may be a divalent cyclic saturated organic group in which any two hydrogens are removed from a hetero ring such as pyrrolidine, piperidine, aziridine, azetidine, oxolane, oxane, oxetane, thiolane, thiane, or the like.

The arylene group may be a divalent cyclic hydrocarbon group including an aromatic ring, and may include, e.g., a phenylene group.

In example embodiments, in Chemical Formula 1, R₂ may be a C3 to C7 alkylene group or a C6 to C9 arylene group. For example, R₂ may be a propylene group, a butylene group, a pentylene group, a hexylene group, a heptylene group, or a phenylene group.

In Chemical Formula 1, m is 0 or 1.

According to embodiments, the cyclic amide-based compound may include at least one selected from the group consisting of γ-valerolactam, ε-caprolactam, N-methyl-ε-caprolactam, N-vinyl-ε-caprolactam, ω-heptaractam, ω-octaractam, glycyl-L-prolineactam, isatin and vince lactam.

In example embodiments, a content of the cyclic amide-based compound may be in a range from 0.001 wt % to 10 wt % based on the total weight of the composition. In some embodiments, the content of the cyclic amide-based compound may be in a range from 0.001 wt % to 5 wt %, from 0.001 wt % to 1 wt %, or from 0.005 wt % to 1 wt %.

In the above range, corrosion of a metal layer may be suppressed without inhibiting the reaction between the fluorine-based compound and the silicone-based polymer.

The cleaning composition includes a polar aprotic solvent. The polar aprotic solvent may penetrate between chains of the silicone-based polymer that is an object of removal to cause swelling of the silicone-based polymer. Further, the polar aprotic solvent may dissolve the fluorine-based compound and the decomposed silicone-based oligomer.

The polar aprotic solvent may promote dissociation and sequestration of the cations and anions of the fluorine-based compound, thereby increasing a concentration of fluorine ions that may participate in the reaction with the silicone-based polymer. Accordingly, cleaning performance of the composition for a silicone-based resin may be improved.

In example embodiments, the polar aprotic solvent may include at least one selected from the group consisting of a linear amide-based solvent, an amine-based solvent, a ketone-based solvent, a morpholine-based solvent, a pyrrolidine-based solvent, a pyrrolidone-based solvent, a urea-based solvent, a lactone-based solvent, a sulfoxide-based solvent, a phosphate-based solvent, a oxazolidone-based solvent, a piperazine-based solvent, and an alkylene glycol alkylether-based solvent.

Non-limiting examples of the linear amide-based solvent may include N,N-dimethylformamide, N,N-diethylformamide, N,N-dipropylformamide, N,N-dimethylacetamide, N,N-diethylacetamide, N,N-dipropylacetamide, N-ethyl-N-methylacetamide, N,N-dimethylpropionamide, N,N-dimethylbutyramide, N,N-dimethylisobutyramide, N,N-dimethylpentanamide, N,N-dimethylpropanamide, N,N-diethylpropanamide, N,N-dibutylpropanamide, etc.

The amine-based solvents may include primary to tertiary aliphatic amines, an alicyclic amine, a heterocyclic amine, an aromatic amines, etc.

Non-limiting examples of the ketone-based solvent may include 2-butanone, dicyclopropyl ketone, cyclopropyl methyl ketone, cyclopentanone, cyclohexanone, cycloheptanone, 3-pentanone, 2-pentanone, 3-methyl-2-pentanone, acetylacetone, 3-methyl-2-pentanone, 4-methyl-2-pentanone, 2-methyl-3-pentanone, 3-hexanone, 2-hexanone, dicycloketone, 1-cyclopentylethanone, 3-methyl-2-hexanone, 2-methyl-3-hexanone, isoamyl ketone, amyl ketone, 4-heptanone, 3-heptanone, 2-heptanone, 5-nonanone, 2,4-dimethyl-3-pentanone, ethyl-isobutyl ketone, 3,5-dimethylcyclohexanone, 2,6-dimethylcyclohexanone, 3-octanone, 5-methyl-2-hexanone, 5-methyl-3-heptanone, 3-methyl-4-heptanone, 2,5-dimethyl-3-hexanone, 2,6-dimethyl-4-hexanone, 2,6-dimethyl-4-heptanone, etc.

The pyridine-based solvent may include a compound represented by Chemical Formula 2 below.

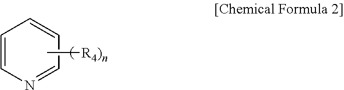

In Chemical Formula 2, R₄ may be hydrogen, a C1 to C10 straight chain aliphatic hydrocarbon group, or a C3 to C10 branched chain aliphatic hydrocarbon group, halogen (e.g., F, Cl, Br, or I), an aldehyde group (—CHO), an acetaldehyde group (—COCH₃), a C1 to C4 alkoxy group, a vinyl group, an acetylene group, a cyano group (—CN), or a methyl sulfide group (—SCH₃).

Non-limiting examples of the pyridine-based solvent may include pyridine, 2-methylpyridine, 3-methylpyridine, 4-methylpyridine, 4-ethylpyridine, 4-propylpyridine, 4-isopropylpyridine, 4-amylpyridine, 2,3-lutidine, 2,4-lutidine, 2,5-lutidine, 3,4-lutidine, 3,5-lutidine, or 2,4,6-trimethylpyridine.

The morpholine-based solvent may be represented by Chemical Formula 3 below.

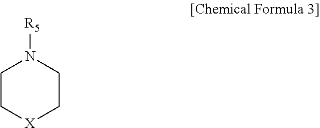

In Chemical Formula 3, R₅ may be hydrogen; a C1 to C6 straight chain aliphatic hydrocarbon group, or a C3 to C6 branched chain aliphatic hydrocarbon group; a vinyl group; a cyano group (—CN); a C1 to C4 aliphatic hydrocarbon group substituted with a tertiary amine; a phenyl group or a pyridine group substituted with a C1 to C4 alkyl group, a cyano group (—CN), a halogen group (e.g., F, Cl, Br, I) or an aldehyde group (—CHO). X may be oxygen or —NR₆—. R₆ may be a C1 to C4 aliphatic hydrocarbon group.

Non-limiting examples of the morpholine-based solvent may include N-methylmorpholine, N-ethylmorpholine, N-arylmorpholine, N-butylmorpholine, N-isobutylmorpholine, or the like.

Non-limiting examples of the pyrrolidone-based solvent may include N-methylpyrrolidone (NMP), N-ethylpyrrolidone (NEP), N-vinylpyrrolidone (NVP), or the like.

The urea-based solvent may include a compound represented by Chemical Formula 4.

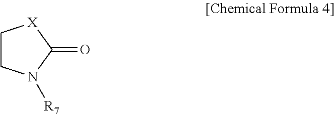

In Chemical Formula 4, X may be oxygen or —NR₈—, and R₈ may be a C1 to C6 straight chain aliphatic hydrocarbon group; a C3 to C6 branched chain or cyclic aliphatic hydrocarbon group; or a C1 to C4 aliphatic hydrocarbon group substituted with a vinyl group, a phenyl group, an acetylene group, a methoxy group, or a dimethylamino group.

Non-limiting examples of the urea-based solvent may include tetramethylurea, tetraethylurea, tetrabutylurea, or the like.

The phosphate-based solvent may include a compound represented by Chemical Formula 5.

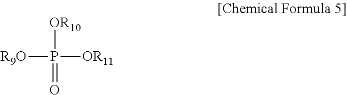

In Chemical Formula 5, R₉ to Ru may each independently be a C1 to C8 straight chain aliphatic hydrocarbon group, or a C3 to C8 branched chain aliphatic hydrocarbon group; a C3 to C8 divalent aliphatic hydrocarbon group forming a ring with an adjacent oxygen atom; a phenyl group unsubstituted or substituted with a C1 to C4 aliphatic hydrocarbon group; a C2 to C4 aliphatic hydrocarbon group substituted with halogen (e.g., F, Cl, Br, I); or a phenyl group substituted with halogen.

Non-limiting examples of the phosphate-based solvent may include triethyl phosphate, tributyl phosphate, triamyl phosphate, triallyl phosphate, or the like.

Non-limiting examples of the lactone-based solvent may include beta-butyrolactone, gamma-caprolactone, gamma-heptanolactone, gamma-octanolactone, gamma-nonalactone, gamma-decanolactone, delta-caprolactone, delta-heptanolactone, delta-octanolactone, delta-nonalactone, delta-decanolactone, delta-dodecanolactone, or the like.

Non-limiting examples of the sulfoxide-based solvent may include dimethyl sulfoxide (DMSO), dibutyl sulfoxide, diphenyl sulfoxide, dibenzyl sulfoxide, methylphenyl sulfoxide, or the like.

Non-limiting examples of the oxazolidone-based solvent may include 2-oxazolidone, 3-methyl-2-oxazolidone, or the like.

Non-limiting examples of the piperazine-based solvent may include dimethyl piperazine, dibutyl piperazine, or the like.

The alkylene glycol alkyl ether solvent may be represented by Chemical Formula 6.

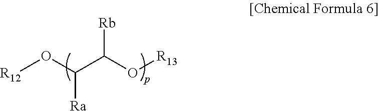

In Chemical Formula 6, R₁₂ and R₁₃ may each independently be a C1 to C4 alkyl group, Rₐ and R_{b} may each independently be hydrogen or a methyl group, and p is an integer of 2 to 4.

Non-limiting examples of the alkylene glycol alkyl ether solvent may include diethylene glycol diethyl ether (diglyme), diethylene glycol methyl ether, triethylene glycol dimethyl ether (triglyme), tetraethylenedimethyl ether (tetraglyme), dipropylene glycol dimethyl ether, or the like.

As the polar aprotic solvent, the above-described compounds may be used alone or in a combination with two or more therefrom. For example, the polar aprotic solvent may include the amide-based solvent and the alkylene glycol alkyl ether solvent, the amide-based solvent and the ketone-based solvent, the sulfoxide-based solvent and the ketone-based solvent, or the amide-based solvent and the ketone-based solvent.

In example embodiments, the polar aprotic solvent may be included in the cleaning composition in a residual amount except for a solid content. The residual amount may refer to a content based on the total weight of the composition excluding the cyclic amide-based compound and the fluorine-based compound, which may be a solute. The residual amount may refer to a variable content changed according to an addition of additional other components.

In example embodiments, a content of the polar aprotic solvent may be in a range from 88 wt % to 99 wt % based on the total weight of the composition. In some embodiments, the content of the polar aprotic solvent may be in a range from 89 wt % to 97 wt % based on the total weight of the composition.

In some embodiments, the cleaning composition may further include water. In an embodiment, water may be included in the cleaning composition in the form of a hydrate with the fluorine-based compound. In an embodiment, water may be separately added to the cleaning composition.

A content of water may be 4 wt % or less based on the total weight of the cleaning composition. In some embodiments, the content of water may be 3 wt % or less, or 2 wt % or less based on the total weight of the cleaning composition. In the above content range, corrosion of the metal layer may be prevented.

In example embodiments, the cleaning composition may not include an ammonium hydroxide-based compound, a metal hydroxide, an alcohol-based compound, a carboxylic acid-based compound, a peroxide compound, or an inorganic acid compound.

For example, the ammonium hydroxide-based compound may include ammonium hydroxide, trimethylammonium hydroxide, triethylammonium hydroxide, etc.

For example, the metal hydroxide may contain NaOH, KOH, Ca(OH)₂, Al(OH)₃, etc.

For example, the alcohol-based compound may include methanol, ethanol, isopropyl alcohol (IPA), methoxypropanol, or the like.

For example, the carboxylic acid-based compound may be an organic acid, and the organic acid may include formic acid, acetic acid, propionic acid, butyric acid, palmitic acid, stearic acid, oleic acid, oxalic acid, malonic acid, succinic acid, tartaric acid, maleic acid, glycolic acid, glutaric acid, adipic acid, sulfosuccinic acid, valeric acid, caproic acid, caprylic acid, capric acid, lauric acid, myristic acid, lactic acid, malic acid, citric acid, tartaric acid, benzoic acid, salicylic acid, paratoluenesulfonic acid, naphthoic acid, nicotinic acid, toluic acid, anisic acid, cumin acid, phthalic acid, etc.

For example, the peroxide compound may include hydrogen peroxide, benzoyl peroxide, ammonium persulfate, etc.

For example, the inorganic acid compound may include hydrochloric acid, phosphoric acid, sulfuric acid, boric acid, nitric acid, hydrobromic acid, iodic acid, etc.

In some embodiments, the cleaning composition may substantially consist of the cyclic amide-based compound, the polar aprotic solvent, and the fluorine-based compound. For example, the cleaning composition may not include any other components except for the cyclic amide-based compound, the polar aprotic solvent and the fluorine-based compound. For example, a sum of the contents of the cyclic amide-based compound, the polar aprotic solvent and the fluorine-based compound based on the total weight of the cleaning composition may be 100 wt %.

The cleaning composition may dissolve the silicone-based polymer. For example, the silicone-based polymer may include a linear silicone-based polymer or a network-type silicone-based polymer formed by crosslinking of the linear silicone-based polymers.

The silicone-based polymer may be a main component of the silicone adhesive as described above. For example, the silicone-based polymer may include a polydimethylsiloxane-based polymer, a polyorganosiloxane-based polymer, or the like.

The cleaning composition may remove a layer including the silicone-based polymer at a rate of 10 μm/min or greater. For example, when a wafer on which the layer including the silicone-based polymer is formed is immersed in the cleaning composition, a thickness of the layer may be decreased by 10 μm or greater for 1 minute.

In the above range, the silicon-based polymer may be removed more quickly, and productivity of a semiconductor device may be improved.

In example embodiments, the cleaning composition may have a low etching rate for a metallic member. The metallic member may include a metal wiring, a bump ball, or other metal members including a metal or consisting of a metal in the semiconductor device.

For example, non-limiting examples of the metallic member include Sn, a Sn-containing alloy such as a Sn—Ag alloy, a Sn—Au alloy, a Sn—Ag—Cu alloy; a double-layered structure or a triple-layered structure such as Sn/Cu, Sn/Ni, Sn/Ni/Cu, Sn—Ag/Cu, Sn—Ag/Ni, Sn—Ag/Ni/Cu, Sn—Au/Cu, Sn—Au/Ni, Sn—Au/Ni/Cu, Sn—Ag—Cu/Ni, Sn—Ag—Cu/Ni/Cu, Sn—Ag—Cu/Cu; a metal layer consisting of Cu, etc.

For example, a surface of the metallic member may not be damaged or discolored even when being exposed to the cleaning composition. Accordingly, the cleaning composition may be utilized in the fabrication of the semiconductor device used in an optical equipment.

For example, the cleaning composition may not transform a surface morphology of the metallic member. Accordingly, a high-quality semiconductor device may be provided.

The cleaning composition can be used in various semiconductor manufacturing processes. As described above, the cleaning composition may be used in a cleaning process of the silicone-based adhesive, but application examples of the cleaning composition are not limited thereto. For example, the cleaning composition may also be applied in the cleaning process of an acrylic adhesive or in a cleaning process of residues remaining after removing an adhesive tape.

Hereinafter, experimental examples are proposed to more concretely describe the present invention. However, the following examples are only given for illustrating the present invention and those skilled in the related art will obviously understand that various alterations and modifications are possible within the scope and spirit of the present invention. Such alterations and modifications are duly included in the appended claims.

### EXAMPLES AND COMPARATIVE EXAMPLES

As shown in Tables 1 and 2 below, cleaning compositions were prepared by adjusting types and contents of the fluorine-based compound, the polar aprotic solvent, and the cyclic amide-based compound. The content of each component is expressed as a weight percent based on the total composition weight.

TABLE 1

| | fluorine-based | | | | | | other | |
|---|---|---|---|---|---|---|---|---|
| | compound | | polar aprotic solvent | | cyclic amide | | component | |
| | type | content | type | content | type | content | type | content |
| Example 1 | A-1 | 5 | B-1 | 94.50 | C-1 | 0.50 | — | — |
| Example 2 | A-2 | 8 | B-1 | 91.00 | C-2 | 1.00 | — | — |
| Example 3 | A-2 | 6 | B-1 | 93.50 | C-1 | 0.50 | — | — |
| Example 4 | A-4 | 8 | B-2 | 91.95 | C-3 | 0.05 | — | — |
| Example 5 | A-5 | 8 | B-3 | 91.95 | C-1 | 0.05 | — | — |
| Example 6 | A-2 | 5 | B-4 | 94.00 | C-1 | 1.00 | — | — |
| Example 7 | A-2 | 7 | B-5 | 92.50 | C-3 | 0.50 | — | — |
| Example 8 | A-3 | 7 | B-6 | 91.00 | C-4 | 2.00 | — | — |
| Example 9 | A-2 | 5 | B-7 | 94.50 | C-1 | 0.50 | — | — |
| Example 10 | A-2 | 10 | B-8 | 89.98 | C-1 | 0.02 | — | — |
| Example 11 | A-2 | 8 | B-4 | 91.20 | C-3 | 0.80 | — | — |
| Example 12 | A-2 | 5 | B-6 | 70.00 | C-5 | 1.00 | — | — |
| | | | B-9 | 24.00 | | | | |
| Example 13 | A-2 | 5 | B-6 | 24.50 | C-3 | 0.50 | — | — |
| | | | B-3 | 70.00 | | | | |
| Example 14 | A-2 | 4 | B-10 | 35.00 | C-6 | 0.01 | — | — |
| | | | B-11 | 60.99 | | | | |
| Example 15 | A-3 | 10 | B-1 | 35.00 | C-1 | 5.00 | — | — |
| | | | B-12 | 55.00 | | | | |
| Example 16 | A-2 | 5 | B-6 | 69.00 | C-1 | 1.00 | — | — |
| | | | B-13 | 25.00 | | | | |
| Example 17 | A-1 | 0.05 | B-1 | 97.95 | C-1 | 2 | — | — |
| Example 18 | A-1 | 0.1 | B-1 | 97.90 | C-1 | 2 | — | — |
| Example 19 | A-1 | 3 | B-1 | 95.00 | C-1 | 2 | — | — |
| Example 20 | A-1 | 15 | B-1 | 83.00 | C-1 | 2 | — | — |
| Example 21 | A-1 | 6 | B-1 | 93.999 | C-1 | 0.001 | — | — |
| Example 22 | A-1 | 6 | B-1 | 93.995 | C-1 | 0.005 | — | — |
| Example 23 | A-1 | 6 | B-1 | 93.00 | C-1 | 1 | — | — |
| Example 24 | A-1 | 6 | B-1 | 89.00 | C-1 | 5 | — | — |
| Example 25 | A-1 | 6 | B-1 | 84.00 | C-1 | 10 | — | — |
| Example 26 | A-1 | 6 | B-1 | 81.00 | C-1 | 13 | — | — |
| Example 27 | A-1 | 6 | B-1 | 90.00 | C-1 | 2 | D-3 | 2 |

TABLE 2

| | fluorine-based | | | | | | other | |
|---|---|---|---|---|---|---|---|---|
| | compound | | solvent | | cyclic amide | | component | |
| | type | content | type | content | type | content | type | content |
| Comparative | A-1 | 8 | B-10 | 90.58 | — | — | D-1 | 0.42 |
| Example 1 | | | | | | | D-2 | 1 |
| Comparative | A-1 | 8 | B-10 | 87.00 | — | — | D-1 | 8 |
| Example 2 | | | | | | | D-3 | 2 |
| Comparative | A-1 | 8 | B-10 | 82.00 | — | — | D-5 | 10 |
| Example 3 | | | | | | | | |
| Comparative | A-1 | 8 | B-10 | 88.77 | — | — | D-1 | 2.23 |
| Example 4 | | | | | | | D-4 | 1 |
| Comparative | A-1 | 8 | B-10 | 87.00 | — | — | D-6 | 5 |
| Example 5 | | | | | | | | |
| Comparative | A-1 | 8 | B-4 | 92.00 | — | — | — | — |
| Example 6 | | | | | | | | |
| Comparative | A-1 | 3 | E-1 | 95.00 | C-1 | 2 | — | — |
| Example 7 | | | | | | | | |
| Comparative | A-1 | 6 | E-2 | 92.00 | C-1 | 2 | — | — |
| Example 8 | | | | | | | | |
| Comparative | — | — | B-10 | 98.00 | C-1 | 2 | — | — |
| Example 9 | | | | | | | | |

A-1: tetrabutylammonium bifluoride (TBAF·HF)
A-2: tetrabutylammonium fluoride trihydrate (TBAF)
A-3: benzyltetramethylammonium fluoride hydrate (BTMAF)
A-4: tetrabutylphosphonium fluoride
A-5: tributylsulfonium fluoride
B-1: diethylacetamide
B-2: diethylformamide
B-3: ethylpyrrolidone
B-4: gamma-butyrolactone
B-5: triethylphosphate
B-6: dimethylpropanamide
B-7: pyridine
B-8: ethylpyrrolidone
B-9: triglyme
B-10: dimethylsulfoxide
B-11:3-pentanone
B-12:3-octanone
B-13: diglyme
C-1: ε-caprolactam
C-2: N-methyl-ε-caprolactam
C-3: γ-valerolactam
C-4: Isatin
C-5: ω-heptalactam
C-6: ω-octalactam
D-1: water
D-2: nitric acid
D-3: tetramethylammonium hydroxide
D-4: hydrogen peroxide
D-5: isopropyl alcohol
D-6: acetic acid
E-1: hexane
E-2: ethanol

### Experimental Example

Properties of the cleaning compositions of Examples and Comparative Examples were evaluated by the following methods, and the results are shown in Table 3.

### (1) Evaluation on Removal Rate of Network-Type Silicone Polymer

A wafer on which a 50 μm-thick cured silicone polymer was formed was cut into a size of 2×2 cm² to prepare samples. The prepared samples were immersed in the cleaning compositions of Examples and Comparative Examples for 1 minute while stirring at 400 rpm at 25° C., rinsed with isopropyl alcohol (IPA), and dried. After drying, a layer thickness of the cured silicone polymer was measured using a scanning electron microscope (SEM), and a removal rate was calculated using Equation 1 below. The removal rate was evaluated according to Evaluation Criteria below.

Removal rate (μm/min)=[50 (μm)−thickness after drying (μm)]/immersion time (min) [Equation 1]

### <Evaluation Criteria>

∘: 20 μm/min or higher
Δ: 10 μm/min or higher, and less than 20 μm/min
X: Less than 10 μm/min

### (2) Evaluation on Linear Silicone Polymer Removal Performance

A blend of a polydimethylsiloxane prepolymer and a curing agent in a predetermined mass ratio was spin-coated on a silicon wafer and cut into a size of 2×2 cm² to prepare a sample. The prepared samples was immersed in the cleaning compositions of Examples and Comparative Examples for 1 minute while stirring at 400 rpm at 25° C., rinsed with isopropyl alcohol (IPA), and dried. After drying, residues on a wafer surface were observed using an SEM and evaluated according to Evaluation Criteria below.

### <Evaluation Criteria>

∘: No residue
X: Residues were observed

### (3) Evaluation on Metal Layer Corrosion

1) A wafer on which Sn—Ag/Ni/Cu bump balls were formed were cut into a size of 2×2 cm² to prepare samples. The prepared samples were immersed in the cleaning composition of Examples and Comparative Examples for 1 minute while stirring at 400 rpm at 25° C., rinsed with isopropyl alcohol (IPA), and dried.

After drying, the number of damaged bump balls was checked using an SEM, and a metal layer corrosion was evaluated according to Evaluation Criteria below.

### <Evaluation Criteria>

∘: less than 5
Δ: 5 or more, and less than 20
X: 20 or more
2) A wafer on which a copper layer, a tin layer, or an aluminum layer was formed by a sputtering process was cut into a size of 2×2 cm² to prepare samples. The prepared samples were immersed in the cleaning compositions of Examples and Comparative Examples for 1 minute while stirring at 400 rpm at 25° C., rinsed with isopropyl alcohol (IPA), and dried. After drying, surface discoloration and morphological changes were observed by an optical microscope, and a metal layer corrosion was evaluated according to Evaluation Criteria below.

### <Evaluation Criteria>

∘: No surface morphological change or discoloration
Δ: Surface morphological change or discoloration was observed
X: Surface morphological change and discoloration were observed

TABLE 3

| | network-type | | metal layer corrosion | | | |
|---|---|---|---|---|---|---|
| | silicone polymer | linear polymer | bump ball | | | |
| | removal rate | removal | damage | copper | tin | aluminum |
| Example 1 | ◯ | ◯ | ◯ | ◯ | ◯ | ◯ |
| Example 2 | ◯ | ◯ | ◯ | ◯ | ◯ | ◯ |
| Example 3 | ◯ | ◯ | ◯ | ◯ | ◯ | ◯ |
| Example 4 | ◯ | ◯ | ◯ | ◯ | ◯ | ◯ |
| Example 5 | ◯ | ◯ | ◯ | ◯ | ◯ | ◯ |
| Example 6 | ◯ | ◯ | ◯ | ◯ | ◯ | ◯ |
| Example 7 | ◯ | ◯ | ◯ | ◯ | ◯ | ◯ |
| Example 8 | ◯ | ◯ | ◯ | ◯ | ◯ | ◯ |
| Example 9 | ◯ | ◯ | ◯ | ◯ | ◯ | ◯ |
| Example 10 | ◯ | ◯ | ◯ | ◯ | ◯ | ◯ |
| Example 11 | ◯ | ◯ | ◯ | ◯ | ◯ | ◯ |
| Example 12 | ◯ | ◯ | ◯ | ◯ | ◯ | ◯ |
| Example 13 | ◯ | ◯ | ◯ | ◯ | ◯ | ◯ |
| Example 14 | ◯ | ◯ | ◯ | ◯ | ◯ | ◯ |
| Example 15 | ◯ | ◯ | ◯ | ◯ | ◯ | ◯ |
| Example 16 | ◯ | ◯ | ◯ | ◯ | ◯ | ◯ |
| Example 17 | Δ | Δ | ◯ | ◯ | ◯ | ◯ |
| Example 18 | Δ | ◯ | ◯ | ◯ | ◯ | ◯ |
| Example 19 | ◯ | ◯ | ◯ | ◯ | ◯ | ◯ |
| Example 20 | ◯ | ◯ | Δ | ◯ | Δ | ◯ |
| Example 21 | ◯ | ◯ | Δ | ◯ | ◯ | ◯ |
| Example 22 | ◯ | ◯ | ◯ | ◯ | ◯ | ◯ |
| Example 23 | ◯ | ◯ | ◯ | ◯ | ◯ | ◯ |
| Example 24 | Δ | ◯ | ◯ | ◯ | ◯ | ◯ |
| Example 25 | Δ | ◯ | ◯ | ◯ | ◯ | ◯ |
| Example 26 | Δ | Δ | ◯ | ◯ | ◯ | ◯ |
| Example 27 | X | Δ | Δ | ◯ | Δ | Δ |
| Comparative | X | X | X | X | X | X |
| Example 1 | | | | | | |
| Comparative | X | X | X | X | X | X |
| Example 2 | | | | | | |
| Comparative | X | Δ | X | X | X | X |
| Example 3 | | | | | | |
| Comparative | X | X | X | X | X | X |
| Example 4 | | | | | | |
| Comparative | X | X | X | X | X | X |
| Example 5 | | | | | | |
| Comparative | ◯ | ◯ | X | Δ | X | Δ |
| Example 6 | | | | | | |
| Comparative | X | X | ◯ | ◯ | ◯ | ◯ |
| Example 7 | | | | | | |
| Comparative | X | Δ | ◯ | ◯ | ◯ | ◯ |
| Example 8 | | | | | | |
| Comparative | X | X | ◯ | ◯ | ◯ | ◯ |
| Example 9 | | | | | | |

Referring to Table 3, the cleaning compositions of Examples were used to implement selective cleaning of the silicone-based polymer. Specifically, the cleaning compositions of Examples were used so that the network-type or the linear silicone-based polymer was rapidly removed from the wafer surface without residues. Further, the bump balls were not damaged, and the metal layer containing copper, tin, aluminum, etc., was not transformed after cleaning with the cleaning compositions.

When the cleaning compositions of Comparative Examples 1 to 6 devoid of the cyclic amide-based compound were used, the silicone-based polymer was not completely removed, and the removal rate was lowered. Further, the cleaning compositions of Comparative Examples 1 to 6 corroded the metal surface, and were not proper for use in a wafer cleaning process.

The cleaning compositions of Comparative Examples 7 and 8 contained a nonpolar solvent or a polar protic solvent which reduced the activity of fluorine-based compound, and did not provide sufficient silicone-based polymer removal properties. The cleaning composition of Comparative Example 9 did not contain the fluorine-based compound, and did not sufficiently remove the silicone-based polymer.

What is claimed is:

1. A cleaning composition comprising:
a polar aprotic solvent;
a fluorine-based compound; and
a cyclic amide-based compound represented by Chemical Formula 1: 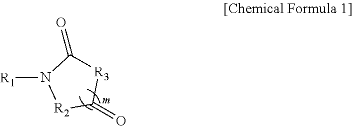
wherein, R₁ is hydrogen, a C1 to C5 alkyl group, or a C2 to C5 alkenyl group,
one of R₂ and R₃ is a C1 to C15 alkylene group, a C2 to C15 alkenylene group, a C3 to C20 cycloalkylene group, a C3 to C20 cycloalkenylene group, or a C6 to C20 arylene group,
the other of R₂ and R₃ is a direct bond, a C1 to C15 alkylene group, a C2 to C15 alkenylene group, a C3 to C20 cycloalkylene group, a C3 to C20 cycloalkenylene group, a C3 to C10 heteroarylene group, a C3 to C10 heterocycloalkylene group, or a C6 to C20 arylene group, and
m is 0 or 1.

2. The cleaning composition of claim 1, wherein, in Chemical Formula 1, R₂ is a C3 to C7 alkylene group or a C6 to C9 arylene group.

3. The cleaning composition of claim 1, wherein, in Chemical Formula 1, R₁ is hydrogen, a methyl group, or a vinyl group.

4. The cleaning composition of claim 1, wherein the cyclic amide-based compound comprises at least one selected from the group consisting of γ-valerolactam, ε-caprolactam, N-methyl-ε-caprolactam, N-vinyl-ε-caprolactam, ω-heptalactam, ω-octalactam, glycyl-L-prolinelactam, isatin, and vince lactam.

5. The cleaning composition of claim 1, wherein a content of the cyclic amide-based compound is in a range from 0.001 wt % to 10 wt % based on a total weight of the composition.

6. The cleaning composition of claim 1, wherein the polar aprotic solvent comprises at least one selected from the group consisting of a linear amide-based solvent, an amine-based solvent, a ketone-based solvents, a morpholine-based solvent, a pyrrolidine-based solvent, a pyrrolidone-based solvent, a urea-based solvent, a lactone-based solvent, a sulfoxide-based solvent, a phosphate-based solvent, an oxazolidone-based solvent, a piperazine-based solvent, and an alkylene glycol alkyl ether-based solvent.

7. The cleaning composition of claim 1, wherein a content of the polar aprotic solvent is in a range from 88 wt % to 99 wt % based on a total weight of the composition.

8. The cleaning composition of claim 1, wherein the fluorine-based compound has an ionic bond of a nitrogen-based cation, a phosphorus-based cation or a sulfur-based cation, and a fluorine anion.

9. The cleaning composition of claim 8, wherein the nitrogen-based cation includes an ammonium-based cation bonded with three or more C1 to C10 alkyl groups.

10. The cleaning composition of claim 1, wherein the fluorine-based compound is in the form of a hydrate.

11. The cleaning composition of claim 1, wherein the fluorine-based compound comprises at least one selected from the group consisting of tetrabutylammonium bifluoride, tetrabutylammonium fluoride, tetraoctylammonium fluoride, benzyltrimethylammonium fluoride, tetra-n-butylammonium fluoride hydrate, tetra-n-butylammonium fluoride trihydrate, benzyltrimethylammonium fluoride hydrate, tributylsulfonium fluoride, and tetrabutylphosphonium fluoride.

12. The cleaning composition of claim 1, wherein a content of the fluorine-based compound is in a range from 1 wt % to 12 wt % based on a total weight of the composition.

13. The cleaning composition of claim 1, wherein the cleaning composition does not contain an ammonium hydroxide compound, a metal hydroxide, an alcohol compound, a carboxylic acid compound, a peroxide compound, or an inorganic acid compound.
